(19) United States
(12) Patent Application Publication
(10) Pub. No.: US 2023/0267925 A1
(43) Pub. Date: Aug. 24, 2023

(54) ELECTRONIC DEVICE FOR GENERATING PERSONALIZED AUTOMATIC SPEECH RECOGNITION MODEL AND METHOD OF THE SAME

(71) Applicant: Samsung Electronics Co., Ltd., Suwon-si (KR)

(72) Inventors: Junesig SUNG, Suwon-si (KR); Shinjae KANG, Suwon-si (KR); Chakladar SUBHOJIT, Suwon-si (KR)

(21) Appl. No.: 17/712,699

(22) Filed: Apr. 4, 2022

Related U.S. Application Data
(63) Continuation of application No. PCT/KR2022/004384, filed on Mar. 29, 2022.

(30) Foreign Application Priority Data
Feb. 22, 2022 (KR) 10-2022-0023245

(51) Int. Cl. G10L 15/183; G10L 25/60; G10L 15/16; G10L 13/10; G10L 25/90; G10L 15/02; G10L 25/18; G10L 15/22; G10L 15/06

(52) U.S. Cl. CPC G10L 15/183; G10L 13/10; G10L 15/02; G10L 15/063; G10L 15/16; G10L 15/22; G10L 25/18; G10L 25/60; G10L 25/90; G10L 2015/025

(57) ABSTRACT

An electronic device is provided. The electronic device includes a processor, and a memory operatively connected to the processor, wherein the memory stores instructions which, when executed, cause the processor to generate multiple sound sources for a designated text including at least one designated word, based on a personalized-text-to-speech model constructed with a designated user voice, and perform deep learning of a personalized automatic speech recognition model by using the multiple generated sound sources.

### CROSS-REFERENCE TO RELATED APPLICATION(S)

This application is a continuation application, claiming priority under §365(c), of an International application No. PCT/KR2022/004384, filed on Mar. 29, 2022, which is based on and claims the benefit of a Korean patent application number 10-2022-0023245, filed on Feb. 22, 2022, in the Korean Intellectual Property Office, the disclosure of which is incorporated by reference herein in its entirety.

### TECHNICAL FIELD

The disclosure relates to an electronic device for generating a personalized automatic speech recognition module and a method therefor.

### BACKGROUND ART

In line with development of technologies, electronic devices have been evolving to be able to perform various functions according to user needs.

There have recently been active attempts to recognize a user’s utterance by using an automatic speech recognition (ASR) model, and to control the function or operation of an electronic device based on text data corresponding to the utterance.

The ASR module may be generated by using a deep learning technology which uses an algorithm configured to automatically classify and learn features of input data in order to recognize human languages and/or characters and to apply and/or process the same.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

When generating a personalized wake-up word recognition or personalized automatic speech recognition model, it may be difficult to secure a sufficient amount of user utterance data for learning, which is necessary for learning, due to inconvenience caused to the user.

Aspects of the disclosure are to address at least the above-mentioned problems and/or disadvantages and to provide at least the advantages described below. Accordingly, an aspect of the disclosure is to provide an electronic device for generating multiple pieces of speech data by using a personalized text-to-speech (P-TTS) model, and for generating a personalized automatic speech recognition model by using the multiple pieces of speech data generated, and a method therefor.

Technical problems to be solved by the disclosure are not limited to the above-mentioned technical problems, and other technical problems not mentioned herein will be clearly understood from the following description by those skilled in the art to which the disclosure pertains.

Additional aspects will be set forth in part in the description which follows and, in part, will be apparent from the description, or may be learned by practice of the presented embodiments.

### Solution to Problem

In accordance with an aspect of the disclosure, an electronic device is provided. The electronic device includes a processor and a memory operatively connected to the processor, wherein the memory stores instructions which, when executed, cause the processor to generate multiple sound sources for a designated text including at least one designated word, based on a personalized-text-to-speech model constructed with a designated user voice, and perform deep learning of a personalized automatic speech recognition model by using the multiple generated sound sources.

In accordance with another aspect of the disclosure, a method by an electronic device is provided. The method includes generating multiple sound sources for a designated text including at least one designated word, based on a personalized-text-to-speech model constructed with a designated user voice, and performing deep learning of a personalized automatic speech recognition model by using the multiple generated sound sources.

### Advantageous Effects of Invention

According to various embodiments, a personalized P-TTS model may be used to generate multiple pieces of speech data regarding a designated text based on designated user utterance speech, and the multiple pieces of speech data generated may be used to generate a personalized automatic speech recognition model.

According to various embodiments, a personalized P-TTS model may be used to generate multiple pieces of speech data regarding a designated text based on designated user utterance speech, thereby avoiding the user’s inconvenience of having to repeatedly making an utterance to acquire speech data for learning.

According to various embodiments, a personalized P-TTS model may be used to generate multiple pieces of speech data regarding a designated text based on designated user utterance speech such that a large amount of speech data for learning can be generated, thereby improving the recognition success ratio of a personalized automatic speech recognition model.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of an electronic device and a server according to an embodiment of the disclosure;

FIG. 3 is a flowchart illustrating an example of a method for generating a personalized automatic speech recognition model by an electronic device according to an embodiment of the disclosure;

FIG. 4 is a flowchart illustrating another example of a method for generating a personalized automatic speech recognition model by an electronic device according to an embodiment of the disclosure;

FIG. 5 is a flowchart illustrating still another example of a method for generating a personalized automatic speech recognition model by an electronic device according to an embodiment of the disclosure;

FIG. 6 is a flowchart illustrating an operation of generating multiple sound sources according to an embodiment of the disclosure;

FIG. 7 is an example of a diagram of a signal flow between an electronic device and a server for generation of a personalized automatic speech recognition model according to an embodiment of the disclosure;

FIG. 8 is another example of a diagram of a signal flow between an electronic device and a server for generation of a personalized automatic speech recognition model according to an embodiment of the disclosure;

FIG. 9 is still another example of a diagram of a signal flow between an electronic device and a server for generation of a personalized automatic speech recognition model according to an embodiment of the disclosure; and

FIG. 10 illustrates an operation of an electronic device based on a personalized automatic speech recognition model according to an embodiment of the disclosure.

The same reference numerals are used to represent the same elements throughout the drawings.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

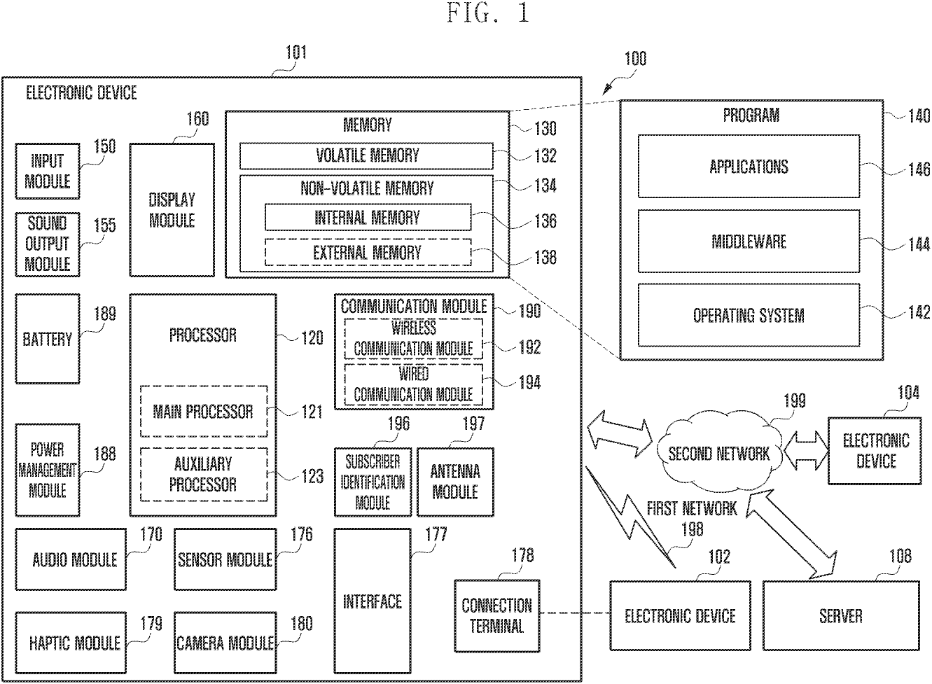

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer’s server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

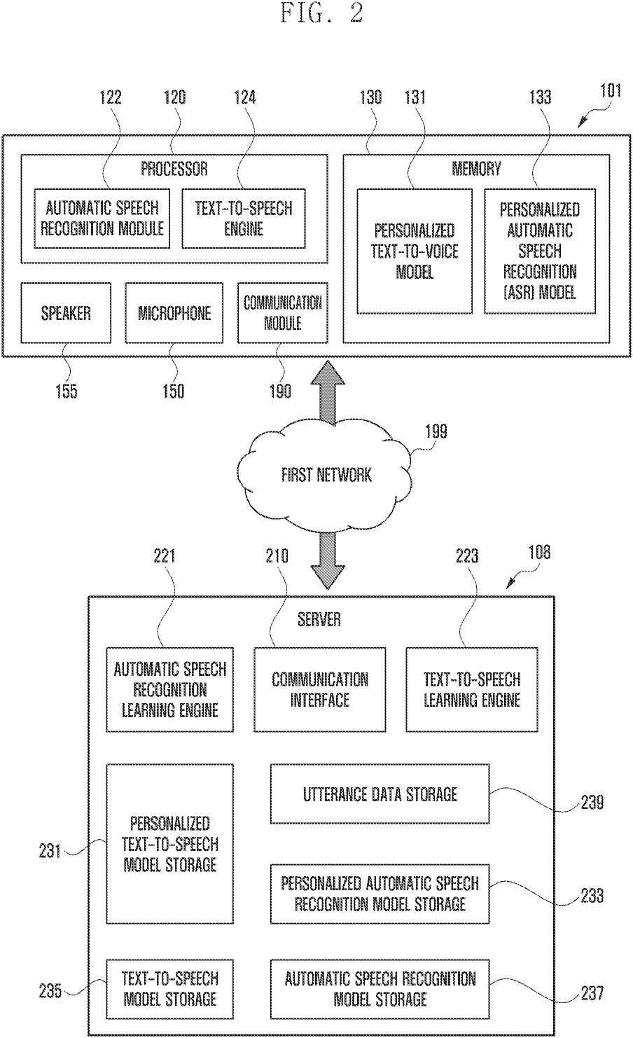

FIG. 2 is a block diagram of an electronic device (e.g., the electronic device 101 of FIG. 1) and a server (e.g., the server 108 of FIG. 1) according to an embodiment of the disclosure.

Referring to FIG. 2, the electronic device 101 may include a processor (e.g., the processor 120 of FIG. 1), a memory (e.g., the memory 130 of FIG. 1), a microphone (e.g., the input module 150 of FIG. 1), a speaker (e.g., the sound output module 155 of FIG. 1), and/or a communication module (e.g., the communication module 190 of FIG. 1).

According to various embodiments, the processor 120 may include an automatic speech recognition module (ASR module) 122 and/or a text-to-speech (TTS) engine (i.e., speech engine 124). According to an embodiment, the automatic speech recognition module 122 may convert a user utterance speech input, which is received through the microphone (i.e., input module 150), into text data. According to an embodiment, the text-to-speech engine 124 may change information of a text format into information of a speech format. According to an embodiment, the processor 120 may output the changed information of a speech format through the speaker (i.e., sound output module 155). Referring to FIG. 2, it is illustrated that the automatic speech recognition module 122 and the text-to-speech engine 124 are implemented as a part of processor 120, but it is not limited thereto. For example, the automatic speech recognition module 122 and the text-to-speech engine 124 may be implemented through the instructions that are stored in the memory 130 and loaded from the memory 130 by the processor 120.

According to various embodiments, the processor 120 may recognize a designated user utterance speech by using a personalized automatic speech recognition model 133. According to an embodiment, the processor 120 may include the automatic speech recognition module 122 in order to recognize the designated user utterance speech by using the personalized automatic speech recognition model 133.

According to an embodiment, the personalized automatic speech recognition model 133 may include an acoustic model and/or a language model, and may be configured to learn to recognize designated user speech data and convert the speech data into text data. For example, the acoustic model may include information related to voicing, and the language model may include unit phoneme information and information about a combination of pieces of unit phoneme information.

According to various embodiments, the personalized automatic speech recognition model 133 may be configured to be learned or updated to recognize a designated user utterance speech, with regard to the automatic speech recognition model (not shown), so as to be generated as a personalized model.

According to various embodiments, the personalized automatic speech recognition model 133 may be configured to be learned or updated to recognize an utterance speech about a designated text including at least one designated word of a designated user, with regard to the automatic speech recognition model (not sown), so as to be generated as a personalized model.

According to various embodiments, the personalized automatic speech recognition model 133 may be configured to be learned to recognize a designated user utterance speech about text including at least one designated word, such as “Hi! Bixby” designated as a wake up word for a wake up command to activate an intelligent speech recognition service. The personalized automatic speech recognition model 133 may be referred to as a personalized wake up speech recognition model.

According to an embodiment, the processor 120 of the electronic device 101 may be configured to use the personalized automatic speech recognition model 133 to recognize a wake up command through the automatic speech recognition module 122.

According to an embodiment, the automatic speech recognition module 122 of processor 120 of the electronic device 101 may include a wake up speech recognition module (not shown) for recognizing a designated user wake up speech.

According to an embodiment, the wake up speech recognition module may be implemented in a low-power processor (e.g., the auxiliary processor 123 of FIG. 1) such as a processor included in an audio codec. According to an embodiment, the wake up speech recognition module may be activated by an utterance input of a wake up word and/or a user input through a hardware key.

According to various embodiments, the automatic speech recognition module 122 including the wake up speech recognition module may recognize a user speech input by using an automatic speech recognition algorithm. The algorithm used for speech recognition may be, for example, at least one of a hidden Markov model (HMM), an artificial neural network (ANN), and dynamic time warping (DTW).

According to various embodiments, the personalized automatic speech recognition model 133 may be generated by performing deep learning and updating of an automatic speech recognition model (not shown) by using multiple pieces of speech data generated for each designated text including at least one word based on a designated user speech.

According to an embodiment, the personalized automatic speech recognition model 133 may be learned using multiple pieces of speech data generated for each designated text including at least one word based on a designated user speech and a designated user utterance speech together.

According to various embodiments, the personalized automatic speech recognition model 133 may be generated by performing learning of an automatic speech recognition model (not shown) by using multiple pieces of speech data generated for each designated text, based on a designated user speech. According to an embodiment, the personalized automatic speech recognition model 133 may be learned by using multiple pieces of speech data generated for each designated text and a user utterance speech about the designated text together, based on a designated user speech.

According to various embodiments, as an automatic speech recognition method (or an automatic speech recognition algorithm) may include at least one of a hidden Markov model (HMM)-based method, an artificial neural network (ANN)-based method, a support vector machine (SVM)-based method, and a dynamic time warping (DTW)-based method, but it is not limited thereto. Automatic speech recognition models to be referenced according to the automatic speech recognition methods may be different.

According to an embodiment, a deep neural network-hidden Markov model (DNN-HMM) may be used as the automatic speech recognition method [Reference 1: G.E. Dahl, D. Yu, L. Deng, and A. Acero, “Pretrained deep neural networks for large-vocabulary speech recognition,” Audio, Speech, and Language Processing, IEEE Transactions on, vol. 20, no. 1, pp. 30-42, 2012]. The automatic speech recognition method based on the DNN-HMM may be obtained by performing modeling of an acoustic model (AM) by using a DNN and performing modeling of a language model (LM) by using an HMM.

According to an embodiment, when the DNN-HMM is used as a speech recognition algorithm, the AM or LM may be modified to personalize (update) the automatic speech recognition model. A method for modifying the AM may be implemented by adding an adaptation layer after the last layer of a neural network used in an AM model [Reference 2: S. Mirsamadi, and J. Hansen, “Study on deep neural network acoustic model adaptation for robust far-field speech recognition,” INTERSPEECH, page 2430-2434. ISCA, (2015)].

According to various embodiments, there may be a method for modifying a LM to personalize the automatic speech recognition model. In case of the LM, the personalization of the automatic speech recognition model may be possible by modifying a pronunciation model (PM) in which words are expressed in a phoneme sequence (or senone sequence). As described above, the linguistic expression in the DNN-HMM may be implemented using the weighted finite state transducer (wFST). Pronunciation for a designated word may be personalized by updating the FST (or finite state acceptor (FSA)) information, which express pronunciation, from among FSTs configuring the entire LM. For example, the FST of a designated word of the PM may be modified or a weight may be applied to the arc of the FST [Reference 3: Takaaki Hori, Chiori Hori, Yasuhiro Minami, and Atsushi Nakamura, “Efficient WFST-based one-pass decoding with on-the-fly hypothesis rescoring in extremely large vocabulary continuous speech recognition,” IEEE Trans. on Audio, Speech and Lang. Process., vol. 15, no. 4, pp. 1352-1365, 2007.].

According to various embodiments, the personalized automatic speech recognition model 133 may be generated by performing deep learning by the processor 120 of the electronic device 101 or a model for which deep learning is performed by the server 108 may be received by the electronic device 101 through communication module 190 and stored in the memory 130.

According to various embodiments, multiple pieces of speech data for a designated text based on a designated user speech may be generated using a personalized-text-to-speech model (i.e., speech model 131) constructed with a designated user speech (or learned based on the designated user speech).

According to various embodiments, the personalized text-to-speech model 131 constructed with a designated user speech may include a speech synthesis model (not shown) for generating a designated user speech. According to an embodiment, the personalized text-to-speech model 131 may be generated by performing operations of acquiring a predetermined amount or more of utterance speech of text and sound source pairs from a designated user, and additionally learning the speech synthesis model such that a speech feature extracted from the acquired utterance becomes similar to a speech feature, which is generated with regard to the same text by a speech synthesis model. The personalized text-to-speech model 131 constructed by performing a sufficient number of additional learning may generate a sound source having a tone similar to a designated user speech.

According to an embodiment, the personalized text-to-speech model 131 may be constructed by the server 108. For example, the server 108 may receive, from the electronic device 101, a designated user utterance speech of text and sound source pairs and perform learning by using the received utterance speech, so as to generate the personalized text-to-speech model 131.

According to an embodiment, the electronic device 101 may, if necessary, receive the personalized text-to-speech model 131 from the server 108 through the communication module 190 and store the same in the memory 130.

According to various embodiments, multiple pieces of speech data for a designated text based on a designated user speech may be generated using the personalized text-to-speech model 131 constructed with the designated user speech.

According to various embodiments, multiple pieces of speech data based on a designated user speech or multiple pieces of speech data for a designated text based on a designated user speech may be generated by the processor 120 of the electronic device 101 or generated by the server 108.

According to various embodiments, multiple pieces of speech data based on a designated user speech or multiple pieces of speech data for a designated text based on a designated user speech may include a designated user utterance speech, and may be received through microphone (i.e., input module 150) for example.

According to various embodiments, the processor 120 may be configured to perform a speech preprocessing operation for a user utterance speech data. For example, the processor 120 may include an adaptive echo canceller (AEC) module (not shown), a noise suppression (NS) module (not shown), an end-point detection (EPD) module (not shown), or an automatic gain control (AGC) module (not shown). The adaptive echo canceller module may cancel an echo included in the user utterance speech. The noise suppression module may suppress background noise included in the user utterance speech. The end-point detection module may detect an endpoint of a user speech included in the user utterance speech so as to find a part in which the user speech exists. The automatic gain control module may adjust the volume of the user utterance speech to be suitable for recognition and processing of the user utterance speech.

According to an embodiment, when the personalized text-to-speech model 131 constructed with a designated user speech is stored in the memory 130 of the electronic device 101 for example, the processor 120 may generate multiple pieces of speech data based on a designated user speech or multiple sound sources for a designated text based on a designated user speech, by using the personalized text-to-speech model 131 constructed with a designated user speech.

According to an embodiment, the processor 120 of the electronic device 101 may generate, for example, multiple sound sources for a designated script by using the personalized text-to-speech model 131 constructed with a designated user speech. For example, a designated script may include a random set of sentences, may be prepared to be suitable for a phonetic balance, or may include news sentences or text sentences extracted from a speech input by a designated user through an app such as a usual call app.

According to an embodiment, the processor 120 of the electronic device 101 may include a text-to-speech engine 124 for generating multiple pieces of speech data based on a designated user speech or multiple sound sources for a designated text based on a designated user speech.

According to various embodiments, the server 108 may include a communication interface 210, an automatic speech recognition learning engine 221, a text-to-speech learning engine 223, a personalized text-to-speech model storage 231, a personalized automatic speech recognition model storage 233, a text-to-speech model storage 235, an automatic speech recognition model storage 237, and/or an utterance data storage 239.

According to various embodiments, the processor 120 or the server 108 of the electronic device 101 may generate multiple sound sources by transforming at least one of a sound length and a sound pitch of each of phonemes of a phoneme sequence included in a designated text including at least one word, based on a stored personalized text-to-speech model 131 or a designated user personalized text-to-speech model 131 stored in the personalized text-to-speech model storage 231. According to an embodiment, the server 108 may perform, through the text-to-speech learning engine 223, a sound source generation operation to be described later.

According to various embodiments, the processor 120 or the server 108 of the electronic device 101 may switch text including at least one designated word into a phoneme sequence, and may extract phoneme information required for generation of a sound source based on the sequence and/or relationship of phonemes included in the switched phoneme sequence.

According to various embodiments, the processor 120 or the server 108 of the electronic device 101 may determine the number of prosody frames allocated to each of phonemes included in a switched phoneme sequence. In general, several to tens of prosody frames may be required to pronounce one phoneme.

According to various embodiments, the processor 120 or the server 108 of the electronic device 101 may determine values of prosody frames allocated to each of phonemes included in a switched phoneme sequence, by using phoneme information extracted based on the sequence and/or relationship of phonemes included in the switched phoneme sequence.

According to various embodiments, the processor 120 or the server 108 of the electronic device 101 may convert the prosody frame values determined for prosody frames allocated to each of phonemes included in a switched phoneme sequence into a spectrogram value, so as to generate a sound source for each of the phonemes.

According to various embodiments, the processor 120 or the server 108 of the electronic device 101 may determine prosody frame values by receiving clustered prosody information corresponding to a switched phoneme sequence, and transforming at least one of a sound length and a sound pitch of each of phonemes, based on phoneme information extracted based on the sequence and/or relationship of phonemes included in the switched phoneme sequence and additionally based on clustered prosody information corresponding to the switched phoneme sequence. For example, the length of clustered prosody information may be the same as the length of the switched phoneme sequence. According to an embodiment, the clustered prosody information may be stored in the memory 130 or received from the server 108.

According to an embodiment, in order for the generated sound source to have a continuous sound pitch and/or utterance length, the clustered prosody information may allow the sound length to be subdivided, for example, from 0.05 seconds to 0.50 seconds in units of 0.01 second, to include sufficient prosody information for each 0.01 second unit length, and may allow the sound pitch to be subdivided from the lowest sound pitch to the highest sound pitch to include sufficient prosody information for each unit height. Accordingly, the clustered prosody information may include sufficient data for a designated sound length and/or sound pitch.

According to various embodiments, the processor 120 or the server 108 of the electronic device 101 may add various piece of noise data, which may be generated in various environments, to the generated sound source and allow the same to be used for learning. For example, noise data may be generated by the addition of adaptive echo and/or noise addition.

According to various embodiments, a sound source generated by the processor 120 or the server 108 of the electronic device 101 may include sound source data that is significantly different from an actual utterance speech of a human.

According to various embodiments, the processor 120 of the electronic device 101 or the automatic speech recognition learning engine 221 and/or the text-to-speech learning engine 223 of the server 108 may be configured to perform filtering for multiple generated sound sources, and to perform deep learning of a stored personalized automatic speech recognition model 133 or a designated user personalized automatic speech recognition model stored in the personalized automatic speech recognition model storage 233, by using the filtered sound sources.

According to various embodiments, multiple generated sound sources may be filtered based on various methods and/or criteria.

According to various embodiments, the processor 120 of the electronic device 101, or the speech recognition learning engine 221 and/or the text-to-speech learning engine 223 of the server 108 may be configured to perform filtering for multiple generated sound sources through a sound quality test based on at least one sound quality test method including a perceptual evaluation of speech quality (PESQ). A personalized text-to-speech model according to an embodiment may be generated based on a designated user utterance speech, and the sound source generated accordingly may include various noises due to the influence of various noises included in the designated user utterance speech.

According to an embodiment, the processor 120 of the electronic device 101 or the automatic speech recognition learning engine 221 and/or text-to-speech learning engine 223 of the server 108 may be configured to measure the sound quality of multiple sound sources for each designated text generated by a personalized text-to-speech model, according to a sound quality measurement method such as a PESQ, and to consider a sound source, the measured value of which differs from those of other sound sources by a threshold value or more, as a sound source that does not satisfy learning purpose and exclude the same from learning data.

According to various embodiments, the processor 120 of the electronic device 101, or the automatic speech recognition learning engine 221 and/or text-to-speech learning engine 223 of the server 108 may be configured to perform filtering by performing automatic speech recognition of multiple generated sound sources for each designated text to convert the sound sources into text, and comparing the converted text with each designated text.

According to an embodiment, the processor 120 of the electronic device 101 or the automatic speech recognition learning engine 221 and/or text-to-speech learning engine 223 of the server 108 may be configured to perform automatic speech recognition of multiple generated sound sources for each designated text to convert the sound sources into text. The multiple generated sound sources are used to learn a personalized automatic speech recognition model, and if text recognized through the automatic speech recognition is different from an original text, the sound sources may be determined not to be suitable sound sources that can be used for the personalized automatic speech recognition model learning in order to improve an actual speech recognition rate.

According to various embodiments, the processor 120 of the electronic device 101 or the automatic speech recognition learning engine 221 and/or text-to-speech learning engine 223 of the server 108 may be configured to perform pitch tracking for multiple generated sound sources for each designated text, and to perform filtering for the multiple generated sound sources based on a designated pitch range. For example, it is generally known that the speech range of women is about 80 Hz to about 400 Hz and the speech range of men is about 60 Hz to about 350 Hz, and thus a designated pitch range may be configured based thereon. Therefore, a sound source falling out of the designated pitch range, which is determined to be different from an actual utterance speech by a user, can be excluded.

According to various embodiments, the processor 120 of the electronic device 101 or the automatic speech recognition learning engine 221 and/or text-to-speech learning engine 223 of the server 108 may be configured to determine a sound length for each of phonemes included in multiple generated sound sources for each designated text, and to perform filtering for the multiple generated sound sources based on a designated sound length range. For example, the length of phonemes according to people’s speech may differ depending on the characteristics of language or the voicing speed of the speaker, but the length of phonemes is generally known to be included in the range of 30 ms to 300 ms. Therefore, the range of sound length is configured based the above range and sound sources falling out of the configured range can be excluded.

According to various embodiments, the processor 120 of the electronic device 101 or the automatic speech recognition learning engine 221 of the server 108 may be configured to perform deep learning of the personalized automatic speech recognition model 133 or a designated user personalized automatic speech recognition model stored in the personalized automatic speech recognition model storage 233, by using multiple generated sound sources for each designated text.

According to various embodiments, the processor 120 of the electronic device 101 or the automatic speech recognition learning engine 221 of the server 108 may be configured to perform deep learning of a personalized automatic speech recognition model, by using a designated user utterance speech in addition to multiple generated sound sources for each designated text.

According to various embodiments, the generated personalized automatic speech recognition model may be stored in the memory 130 of the electronic device 101 or the personalized automatic speech recognition model storage 233 of the server 108.

According to various embodiments, an electronic device (e.g., the electronic device 101 of FIG. 1 or FIG. 2) may include a processor (e.g., the processor 120 of FIG. 1 or FIG. 2); and a memory (e.g., the memory 130 of FIG. 1 or FIG. 2) operatively connected to the processor, wherein the memory stores instructions which, when executed, cause the processor to: generate multiple sound sources for a designated text including at least one designated word, based on a personalized-text-to-speech model constructed with a designated user voice; and perform deep learning of a personalized automatic speech recognition model by using the multiple generated sound sources.

According to various embodiments, the processor may be configured to perform filtering for the multiple generated sound sources, and to perform deep learning of the personalized automatic speech recognition model by using the filtered sound sources.

According to various embodiments, the processor may be configured to perform the filtering through a sound quality test based on at least one sound quality test method including a perceptual evaluation of speech quality (PESQ) for the multiple generated sound sources.

According to various embodiments, the processor may be configured to perform the filtering by performing automatic speech recognition of the multiple generated sound sources to convert the sound sources into text, and comparing the converted text with the designated text.

According to various embodiments, the processor may be configured to perform pitch tracking for the multiple generated sound sources, and to perform filtering for the multiple generated sound sources based on a designated pitch range.

According to various embodiments, the processor may be configured to determine a sound length for each of phonemes included in the multiple generated sound sources, and to perform filtering for the multiple generated sound sources based on a designated sound length range.

According to various embodiments, the processor may be configured to transform at least one of a sound length and a sound pitch for each of phonemes of a phoneme sequence included in the text, based on the personalized text-to-speech model, so as to generate the multiple sound sources.

According to various embodiments, the processor may be configured to switch the text into a phoneme sequence, and to extract information required for generation of the multiple sound sources based on the sequence and relationship of phonemes included in the phoneme sequence.

According to various embodiments, the processor may be configured to allocate at least one prosody frame to each of phonemes included in the phoneme sequence, determine a value of the prosody frame based on the extracted information, and convert the determined value of the prosody frame into a spectrogram value so as to generate a sound source for each of the phonemes.

According to various embodiments, an electronic device may include a processor configured to receive clustered prosody information corresponding to the phoneme sequence, and to transform at least one of a sound length and a sound pitch of each of phonemes based on the clustered prosody information.

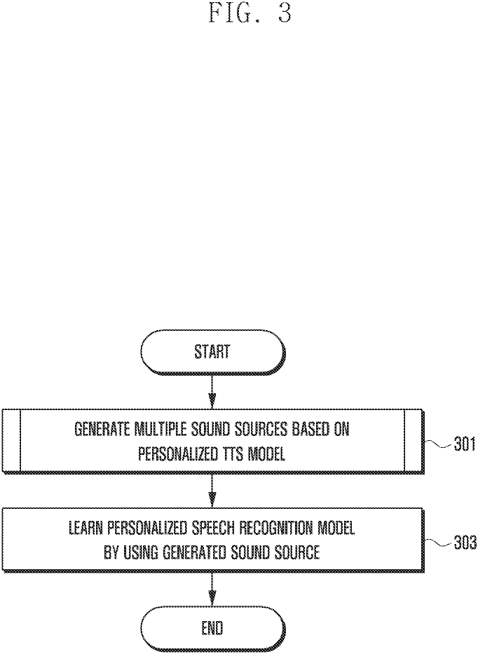

FIG. 3 is a flowchart illustrating an example of a method for generating a personalized automatic speech recognition model according to an embodiment of the disclosure.

Referring to FIG. 3, a method for generating a personalized automatic speech recognition model according to various embodiments may be performed by the electronic device 101 and/or the server 108 of FIG. 2. Hereinafter, a case in which the method is performed by the processor 120 of the electronic device 101 will be described as an example, but various embodiments are not limited thereto.

According to various embodiments, in operation 301, the processor 120 may generate multiple sound sources for a designated text including at least one designated word, based on a personalized text-to-speech model constructed with a designated user speech.

According to an embodiment, a personalized text-to-speech model constructed with a designated user speech may be generated by the processor 120 or received from the server 108.

According to an embodiment, the processor 120 may transform at least one of a sound length and a sound pitch of each of phonemes of a phoneme sequence included in text including at least one word, in order to generate multiple sound sources.

According to various embodiments, the processor 120 may switch text including at least one designated word into a phoneme sequence, may extract phoneme information required for generation of a sound source based on the sequence and/or relationship of phonemes included in a switched phoneme sequence, and may determine the number of prosody frames allocated to each of phonemes included in the switched phoneme sequence.

According to various embodiments, the processor 120 may determine the values of prosody frames allocated to each of phonemes included in a switched phoneme sequence, by using phoneme information extracted based on the sequence and/or relationship of phonemes included in the switched phoneme sequence, and may convert the prosody frame values determined for prosody frames into a spectrogram value so as to generate a sound source for each of the phonemes.

According to various embodiments, the processor 120 may transform at least one of a sound length and a sound pitch of each of phonemes included in a switched phoneme sequence, by using clustered prosody information corresponding to the switched phoneme sequence together with phoneme information extracted based on the sequence and/or relationship of phonemes included in the above-described switched phoneme sequence, so as to determine prosody frame values.

According to various embodiments, in operation 303, the processor 120 may be configured to perform deep learning of the personalized automatic speech recognition model by using multiple generated sound sources.

According to an embodiment, the processor 120 may be configured to perform learning by inputting multiple sound sources generated based on an above-described designated user speech to an acoustic model and/or a language model included in an automatic speech recognition model, extracting information relating to voicing for example with regard to the multiple pieces of input sound source data, analyzing unit phoneme information and information relating to a combination of pieces of unit phoneme information to convert the same into text data, so as to update the acoustic model and/or the language model into a personalized automatic speech recognition model which can recognize a designated user utterance speech.

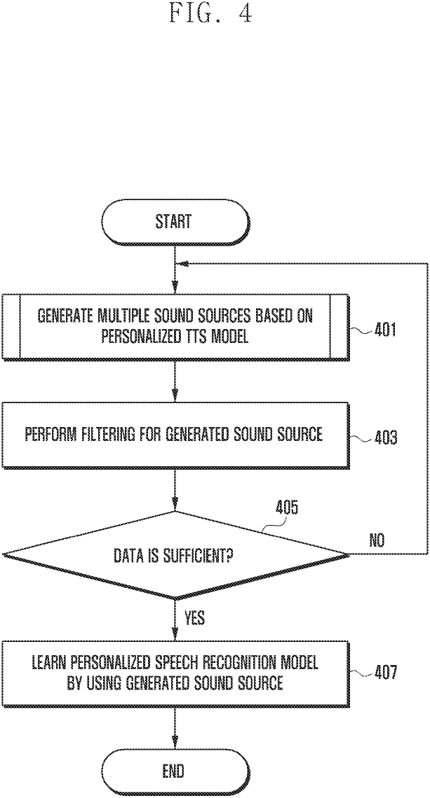

FIG. 4 is a flowchart illustrating another example of a method for generating a personalized automatic speech recognition model according to an embodiment of the disclosure.

Referring to FIG. 4, a method for generating a personalized automatic speech recognition model according to various embodiments may be performed by the electronic device 101 and/or the server 108 of FIG. 2. Hereinafter, a case in which the method is performed by the processor 120 of the electronic device 101 will be described as an example, but various embodiments are not limited thereto.

According to various embodiments, in operation 401, the processor 120 may generate multiple sound sources for a designated text including at least one designated word, based on a personalized text-to-speech model constructed with a designated user speech.

According to an embodiment, a personalized text-to-speech model constructed with a designated user speech may be generated by the processor 120 or received from the server 108.

According to an embodiment, the processor 120 may transform at least one of a sound length and a sound pitch of each of phonemes of a phoneme sequence included in text including at least one word, in order to generate multiple sound sources.

According to various embodiments, the processor 120 may switch text including at least one designated word into a phoneme sequence, may extract phoneme information required for generation of a sound source based on the sequence and/or relationship of phonemes included in a switched phoneme sequence, and may determine the number of prosody frames allocated to each of phonemes included in the switched phoneme sequence.

According to various embodiments, the processor 120 may determine the values of prosody frames allocated to each of phonemes included in a switched phoneme sequence, by using phoneme information extracted based on the sequence and/or relationship of phonemes included in the switched phoneme sequence, and may convert the prosody frame values determined for prosody frames into a spectrogram value so as to generate a sound source for each of the phonemes.

According to various embodiments, the processor 120 may transform at least one of a sound length and a sound pitch of each of phonemes included in a switched phoneme sequence, by using clustered prosody information corresponding to the switched phoneme sequence together with phoneme information extracted based on the sequence and/or relationship of phonemes included in the above-described switched phoneme sequence, so as to determine prosody frame values.

According to various embodiments, in operation 403, the processor 120 may be configured to perform filtering for generated sound sources.

According to various embodiments, multiple generated sound sources may be filtered based on various methods and/or criteria.

According to various embodiments, the processor 120 may be configured to perform filtering for the multiple generated sound sources through a sound quality test based on at least one sound quality test method including a PESQ. The personalized text-to-speech model according to an embodiment may be generated based on a designated user utterance speech, and the sound source generated accordingly may include various noises due to the influence of various noises included in the designated user utterance speech. Therefore, a sound source, having the sound quality value, which is measured according to a sound quality measurement method such as a PESQ, differing from those of other sound sources by a threshold value or more, can be filtered out.

According to various embodiments, the processor 120 may be configured to perform filtering by performing speech recognition of multiple generated sound sources so as to convert the same into text and comparing the converted text with a designated text. The multiple generated sound sources are used to learn a personalized automatic speech recognition model, and if text recognized through the automatic speech recognition is different from an original text, the sound sources may be determined not to be suitable sound sources that can be used for the personalized automatic speech recognition model learning in order to improve an actual speech recognition rate.

According to various embodiments, the processor 120 may be configured to perform pitch tracking for multiple generated sound sources, and to perform filtering for the multiple generated sound sources based on a designated pitch range. For example, the processor 120 may be configured to configure the speech range of women to be in a range of about 80 Hz to about 400 Hz and configure the speech range of men to be in a range about 60 Hz to about 350 Hz, and thus to allow a sound source falling out of the designated pitch range to be excluded.

According to various embodiments, the processor 120 may be configured to determine a sound length for each of phonemes included in multiple generated sound sources, and to perform filtering for the multiple generated sound sources based on a designated sound length range. For example, the processor 120 may be configured to allow sound sources falling out of a configured sound length range, such as about 30 ms to 300 ms, to be excluded.

According to various embodiments, the processor 120 may identify whether the filtered sound source data has a sufficient amount required for learning in operation 405. According to an embodiment, the processor 120 may be configured to, when the filtered sound source data is insufficient, allow an operation to return to operation 401 to additionally generate multiple sound sources.

According to various embodiments, the processor 120 may be configured to perform deep learning of a personalized automatic speech recognition model by using multiple generated sound sources, in operation 407.

According to an embodiment, the processor 120 may be configured to perform learning by inputting multiple sound sources generated based on an above-described designated user speech to an acoustic model and/or a language model included in an automatic speech recognition model, extracting information relating to voicing for example with regard to the multiple pieces of input sound source data, analyzing unit phoneme information and information relating to a combination of pieces of unit phoneme information to convert the same into text data, so as to update the acoustic model and/or a language model into a personalized automatic speech recognition model which can recognize a designated user utterance speech.

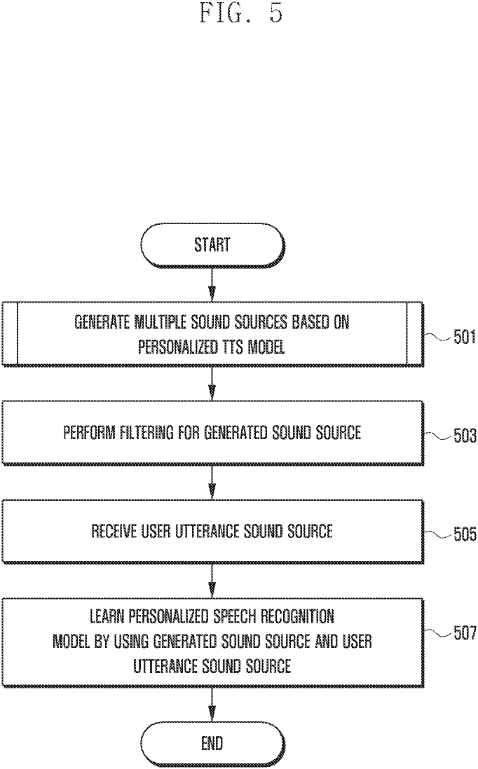

FIG. 5 is a flowchart illustrating still another example of a method for generating a personalized automatic speech recognition model according to an embodiment of the disclosure.

Referring to FIG. 5, a method for generating a personalized automatic speech recognition model according to various embodiments may be performed by the electronic device 101 and/or the server 108 of FIG. 2. Hereinafter, a case in which the method is performed by the processor 120 of the electronic device 101 will be described as an example, but various embodiments are not limited thereto.

According to various embodiments, in operation 501, the processor 120 may generate multiple sound sources for a designated text including at least one designated word, based on a personalized text-to-speech model constructed with a designated user speech.

According to an embodiment, a personalized text-to-speech model constructed with a designated user speech may be generated by the processor 120 or received from the server 108.

According to an embodiment, the processor 120 may transform at least one of a sound length and a sound pitch of each of phonemes of a phoneme sequence included in text including at least one word, in order to generate multiple sound sources.

According to various embodiments, the processor 120 may switch text including at least one designated word into a phoneme sequence, may extract phoneme information required for generation of a sound source based on the sequence and/or relationship of phonemes included in a switched phoneme sequence, and may determine the number of prosody frames allocated to each of phonemes included in a switched phoneme sequence.

According to various embodiments, the processor 120 may determine the values of prosody frames allocated to each of phonemes included in a switched phoneme sequence, using phoneme information extracted based on the sequence and/or relationship of phonemes included in the switched phoneme sequence, and may convert prosody frame values determined for prosody frames into a spectrogram value so as to generate a sound source for each of the phonemes.

According to various embodiments, the processor 120 may be configured to perform filtering of a generated sound source in operation 503.

According to various embodiments, multiple generated sound sources may be filtered based on various methods and/or criteria.

According to various embodiments, the processor 120 may be configured to perform filtering for multiple generated sound sources, by using sound quality test, text comparison by automatic speech recognition, pitch range comparison, and/or sound length comparison methods. For example, the processor 120 may be configured to perform filtering by performing a sound quality test based on at least one sound quality test method including a PESQ, to perform filtering by performing automatic speech recognition for multiple generated sound sources so as to convert the same into text and comparing the converted text with a designated text, to perform pitch tracking for multiple generated sound sources and perform filtering based on a designated pitch range, or to perform filtering by comparing sound length ranges of respective phoneme included in multiple generated sound sources.

According to various embodiments, the processor 120 may receive a user utterance sound source in operation 505.

According to various embodiments, multiple pieces of speech data based on a designated user speech or multiple pieces of speech data for a designated text based on a designated user speech may include a designated user utterance speech, and may be received through a microphone (e.g., the microphone (i.e., input module 150) of FIG. 2) for example.

According to various embodiments, the processor 120 may be configured to perform a speech preprocessing operation for a user utterance speech data. For example, the processor 120 may suppress an echo and/or a background noise included in a user utterance speech. For example, the processor 120 may detect an endpoint of a user speech included in a user utterance speech so as to find a part in which the user’s speech exists or to adjust the volume of a user utterance speech.

According to various embodiments, the processor 120 may be configured to perform deep learning of a personalized automatic voice recognition model by using multiple generated sound sources and a received user utterance sound source, in operation 507.

According to an embodiment, the processor 120 may be configured to perform learning by inputting multiple sound sources generated based on an above-described designated user speech to an acoustic model and/or a language model included in an automatic speech recognition model, extracting information relating to voicing for example with regard to the multiple pieces of input sound source data, analyzing unit phoneme information and information relating to a combination of pieces of unit phoneme information to convert the same into text data, so as to update the acoustic model and/or a language model into a personalized automatic speech recognition model which can recognize a designated user utterance speech.

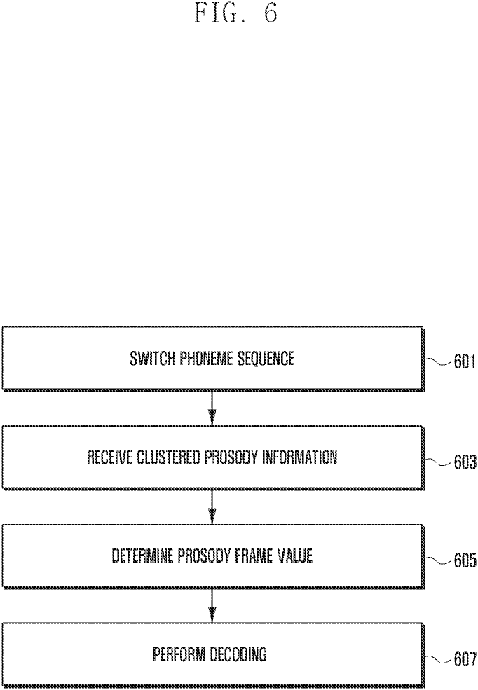

FIG. 6 is a flowchart illustrating an operation of generating multiple sound sources according to an embodiment of the disclosure.

Referring to FIG. 6, a method for generating multiple sound sources according to various embodiments may be performed by the electronic device 101 and/or the server 108 of FIG. 2. Hereinafter, a case in which the operation is performed by the processor 120 of the electronic device 101 will be described as an example, but various embodiments are not limited thereto. The flowchart illustrating an operation of generating multiple sound sources shown in FIG. 6 may include, for example, operations that describe the operation of generating multiple sound sources (e.g., operation 301, operation 401, or operation 501) of FIG. 3, FIG. 4, or FIG. 5 in more detail.

According to various embodiments, the processor 120 may convert text including at least one designated word into a phoneme sequence in operation 601.

According to an embodiment, the processor 120 may extract phoneme information required for generation of a sound source based on the sequence and/or relationship of phonemes included in a switched phoneme sequence.

According to an embodiment, the processor 120 may determine the number of prosody frames allocated to each of phonemes included in a switched phoneme sequence. In general, several to tens of prosody frames may be required to pronounce one phoneme, and thus the processor 120 may allocate the number of prosody frames required to pronounce each of the phonemes.

According to various embodiments, the processor 120 may receive clustered prosody information corresponding to a switched phoneme sequence. For example, the length of clustered prosody information may be the same as the length of a switched phoneme sequence, in operation 603.

According to an embodiment, in order for the generated sound source to have a continuous pitch and/or utterance length, the clustered prosody information may allow the sound length to be subdivided, for example, from 0.05 seconds to 0.50 seconds in units of 0.01 second, to include sufficient prosody information for each 0.01 second unit length, and may allow the sound pitch to be subdivided from the lowest sound pitch to the highest sound pitch to include sufficient prosody information for each unit height. Accordingly, the clustered prosody information may include sufficient data for a designated sound length and/or sound pitch.

According to various embodiments, the processor 120 may determine a prosody frame value of each of prosody frames corresponding to each of phonemes of a switched phoneme sequence, in operation 605.

According to an embodiment, the processor 120 may determine values of prosody frames by transforming at least one of the sound length and the sound pitch of each of phonemes, based on phoneme information extracted based on the sequence and/or relationship of phonemes included in a switched phoneme sequence and clustered prosody information corresponding to the switched phoneme sequence.

According to various embodiments, the processor 120 may convert prosody frame values determined for prosody frames allocated to each of phonemes included in a switched phoneme sequence into a spectrogram value and decoding the value, so as to generate a sound source for each of the phonemes, in operation 607.

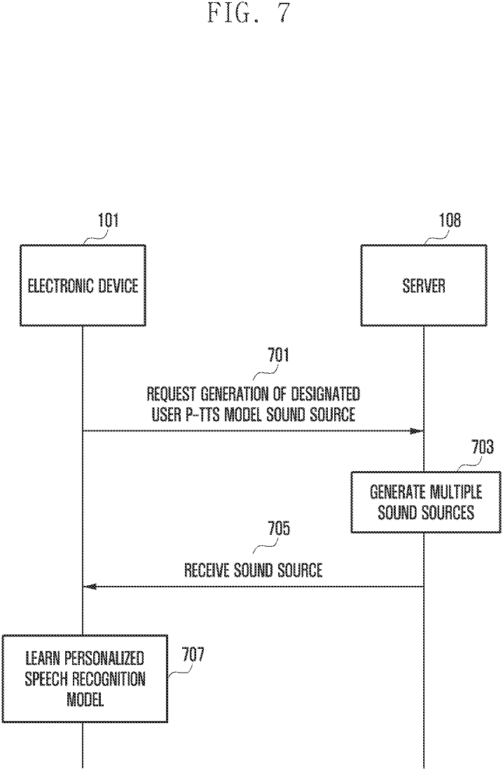

FIG. 7 is an example of a diagram of a signal flow between an electronic device (e.g., the electronic device 101 of FIG. 1 or FIG. 2) and a server (e.g., the server 108 of FIG. 1 or FIG. 2) for generation of a personalized automatic speech recognition model according to an embodiment of the disclosure.

Referring to FIG. 7, the server 108 may store a personalized text-to-speech model for a designated user in a personalized text-to-speech model storage (e.g., the personalized text-to-speech model storage 231 of FIG. 2), and may generate multiple sound sources for a designated text including at least one word of a designated user based on the personalized text-to-speech model. According to an embodiment, the electronic device 101 may be configured to receive multiple sound sources generated from the server 108, and to learn an automatic speech recognition model by using the multiple received sound sources so as to generate a designated user personalized automatic speech recognition model.

According to various embodiments, the electronic device 101 may request a sound source for text including at least one designated word for a designated user from the server 108 in order to generate a personalized automatic speech recognition model of a designated user, in operation 701.

According to an embodiment, the electronic device 101 may transmit information about a designated user and text including at least one designated word to the server 108.

According to an embodiment, the electronic device 101, may transmit, to the server 108, an utterance speech for text including at least one designated word of a designated user.

According to an embodiment, text including at least one designated word may include a wake up word or a designated script.

According to an embodiment, the server 108 may generate multiple sound sources for text including at least one designated word based on a designated user personalized text-to-speech model, in operation 703.

According to an embodiment, the server 108 may obtain a personalized text-to-speech model constructed based on the designated user speech from a personalized text-to-speech model storage (e.g., the personalized text-to-speech model storage 231 of FIG. 2).

According to an embodiment, the server 108 may generate a personalized text-to-speech model through text-to-speech learning engine (e.g., the text-to-speech learning engine 223 of FIG. 2) based on a designated user utterance speech for text including at least one designated word, and may store the generated personalized text-to-speech model in the personalized text-to-speech model storage 231.

According to an embodiment, the server 108 may perform filtering for multiple sound sources generated based on a designated user personalized text-to-speech model.

According to various embodiments, multiple generated sound sources may be filtered based on various methods and/or criteria. According to an embodiment, the server 108 may perform filtering for multiple generated sound sources through a sound quality test based on at least one sound quality test method including a perceptual evaluation of speech quality (PESQ). According to an embodiment, the server 108 may perform automatic speech recognition for multiple generated sound sources so as to convert the same into text, and may compare the converted text with a designated text to perform filtering. According to an embodiment, the server 108 may perform pitch tracking for multiple generated sound sources, and may perform filtering for multiple generated sound sources based on a designated pitch range. According to an embodiment, the server 108 may determine a sound length for each of phonemes included in multiple generated sound sources, and may perform filtering for multiple generated sound sources based on a designated sound length range. According to an embodiment, the server 108 may transmit multiple sound sources, which are generated by filtering out inappropriate sound sources as described above, to the electronic device 101. According to an embodiment, the server 108 may identify whether a sufficient number of sound sources for learning have been generated, and may additionally generate multiple sound sources and perform filtering thereof.

According to various embodiments, the electronic device 101 may receive multiple sound sources from the server 108, in operation 705.

According to various embodiments, the electronic device 101 may be configured to perform deep learning of a personalized automatic speech recognition model by using multiple received sound sources, in operation 707.

According to an embodiment, the electronic device 101 may receive a designated user utterance speech, and may be configured to perform learning of a personalized automatic speech recognition model by using multiple received sound sources and a designated user utterance speech together.

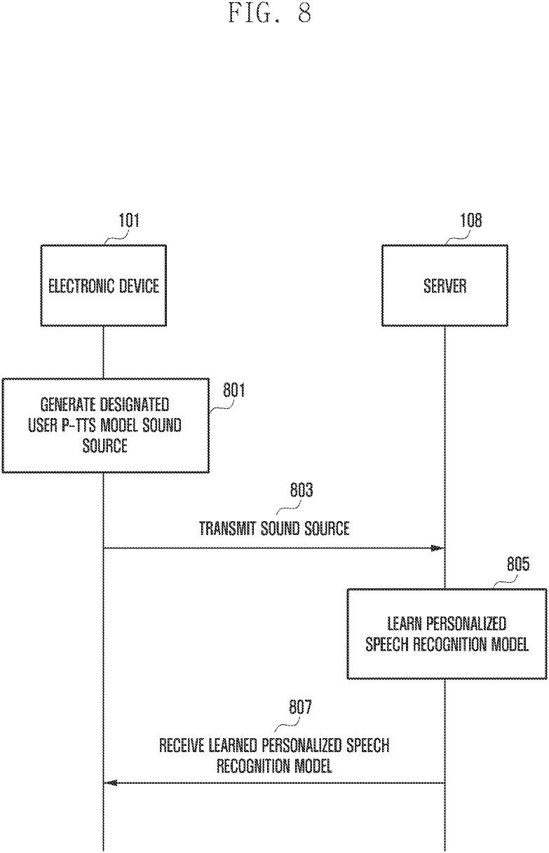

FIG. 8 is another example of a diagram of a signal flow between an electronic device (e.g., the electronic device 101 of FIG. 1 or FIG. 2) and a server (e.g., the server 108 of FIG. 1 or FIG. 2) for generation of a personalized automatic speech recognition model according to an embodiment of the disclosure.

Referring to FIG. 8, the server 108 may learn a personalized automatic speech recognition model through an automatic speech recognition learning engine (e.g., the automatic speech recognition learning engine 221 of FIG. 2). To this end, the electronic device 101 may generate multiple sound sources for a designated text including at least one word of a designated user and transmit the same to the server 108. According to an embodiment, the electronic device 101 may transmit multiple generated sound sources to the server 108 and acquire a learned personalized automatic speech recognition model from the server 108.

According to various embodiments, the electronic device 101 may acquire multiple sound sources for a designated text including at least one designated word, in operation 801.

According to an embodiment, the electronic device 101 may generate multiple sound sources for a designated text including at least one designated word, based on a personalized text-to-speech model constructed with a designated user speech. According to an embodiment, the electronic device 101 may transform at least one of a sound length and a sound pitch of each of phonemes of a phoneme sequence included in text including at least one word, in order to generate multiple sound sources.

According to an embodiment, the electronic device 101 may acquire, as a sound source, a designated user utterance speech for a designated text including at least one designated word.

According to an embodiment, a personalized text-to-speech model constructed with a designated user speech may be generated by the electronic device 101 or received from the server 108.

According to various embodiments, the electronic device 101 may transmit multiple sound sources for text including at least one designated word for a designated user to the server 108, in order to generate a designated user personalized automatic speech recognition model, in operation 803. For example, multiple sound sources for text including at least one designated word for a designated user may be generated or acquired by the electronic device 101 as described above.

According to an embodiment, the electronic device 101 may transmit, to the server 108, multiple sound sources for text including at least one designated word and information on a designated user. According to an embodiment, the electronic device 101 may transmit, to the server 108, a designated user utterance speech for text including at least one designated word. According to an embodiment, text including at least one designated word may include a wake up word or a designated script.

According to an embodiment, the server 108 may generate a personalized automatic speech recognition model by using multiple sound sources for text including at least one designated word, in operation 805.

According to an embodiment, the server 108 may learn a speech recognition model by using multiple sound sources for text including at least one designated word to generate a personalized automatic speech recognition model for a designated user.

According to an embodiment, the server 108 may store a personalized automatic speech recognition model, which is learned based on the designated user speech, in a personalized automatic speech recognition model storage (e.g., the personalized automatic speech recognition model storage 233 of FIG. 2).

According to an embodiment, the electronic device 101 may receive a personalized automatic speech recognition model generated from the server 108, in operation 807.

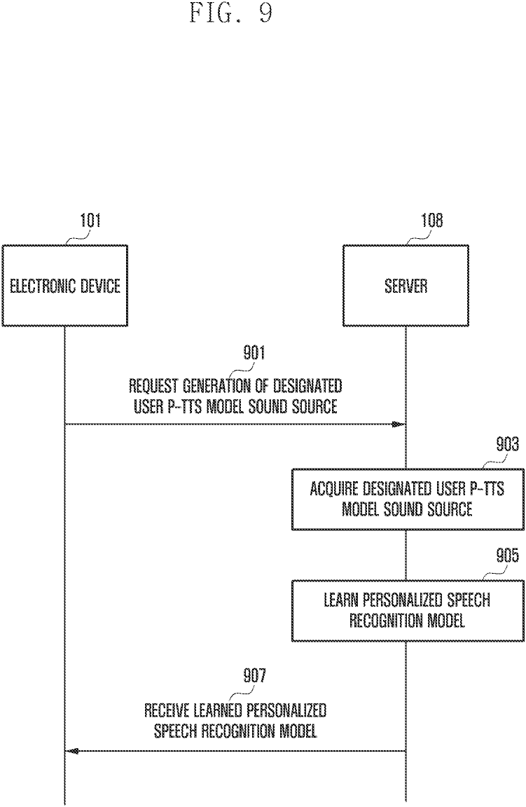

FIG. 9 is still another example of a diagram of signal flow between an electronic device (e.g., the electronic device 101 of FIG. 1 or FIG. 2) and a server (e.g., the server 108 of FIG. 1 or FIG. 2) for generation of a personalized automatic speech recognition model according to an embodiment of the disclosure.

Referring to FIG. 9, the server 108 may learn a personalized automatic speech recognition model through an automatic speech recognition learning engine (e.g., the automatic speech recognition learning engine 221 of FIG. 2). To this end, multiple sound sources for a designated text including at least one word of a designated user may be generated. According to an embodiment, the electronic device 101 may acquire a learned personalized automatic speech recognition model from the server 108.

According to various embodiments, the electronic device 101 may request a designated user personalized automatic speech recognition model from the server 108 in operation 901. According to an embodiment, the electronic device 101 may transmit, to the server 108, information about a designated user and information about text including at least one designated word. According to an embodiment, the electronic device 101 may transmit, to the server 108, a designated user utterance speech for text including at least one designated word. According to an embodiment, text including at least one designated word may include a wake up word or a designated script.

According to various embodiments, the server 108 may generate multiple sound sources for a designated text including at least one designated word, based on a personalized text-to-speech model constructed with a designated user speech, in operation 903.

According to an embodiment, the server 108 may transform at least one of a sound length and a sound pitch of each of phonemes of a phoneme sequence included in text including at least one word, in order to generate multiple sound sources.

According to an embodiment, the server 108 may acquire, as a sound source, a designated user utterance speech for a designated text including at least one designated word.

According to various embodiments, the server 108 may be configured to perform learning of a designated user personalized automatic speech recognition model by using multiple sound sources for text including at least one designated word for a designated user, in operation 905.

According to an embodiment, the server 108 may store a personalized automatic speech recognition model, which is learned based on the designated user speech, in a personalized automatic speech recognition model storage (e.g., personalized automatic speech recognition model storage 233 of FIG. 2).

According to an embodiment, the electronic device 101 may receive a personalized automatic speech recognition model generated from the server 108, in operation 907.

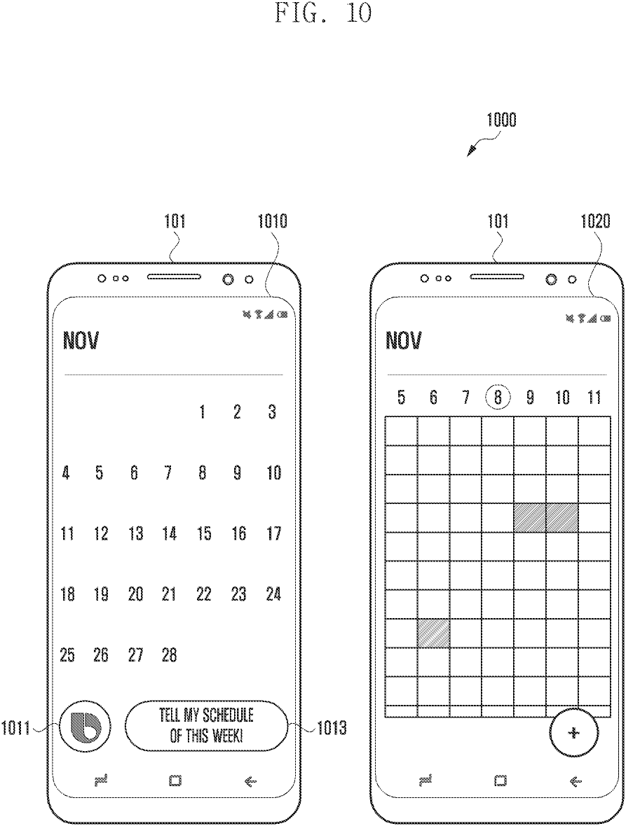

FIG. 10 is diagram 1000 for illustrating an operation of an electronic device (e.g., the electronic device 101 of FIG. 2) based on a personalized automatic speech recognition model according to an embodiment of the disclosure.

According to various embodiments, a personalized automatic speech recognition model may include a personalized automatic speech recognition model for recognition of a designated user utterance speech and/or a wake up speech recognition model for recognition of a designated user utterance speech (e.g., a wake up word) for text including at least one designated word.

According to an embodiment, the electronic device 101 may execute an intelligent app in order to process a user input through an intelligent server (e.g., the server 108 of FIG. 1).

According to an embodiment, on a screen 1010, when recognizing a designated speech input (e.g., wake up!) by using a personalized automatic speech recognition model including a wake up speech recognition model, or receiving an input through a hardware key (e.g., a dedicated hardware key), the electronic device 101 may execute an intelligent app to process a speech input. The electronic device 101 may execute, for example, an intelligent app in a state in which a schedule app is executed.

According to an embodiment, the electronic device 101 may display an object (e.g., an icon) 1011 corresponding to an intelligent app on a display (e.g., display module 160 of FIG. 1). According to an embodiment, the electronic device 101 may receive a speech input by a user utterance. For example, the electronic device 101 may receive a speech input of “Tell my schedule of this week!”. According to an embodiment, the electronic device 101 may recognize a received speech input by using a personalized automatic speech recognition model and convert the received speech input into text. According to an embodiment, the electronic device 101 may display, on a display, a user interface (UI) 1013 (e.g., an input window) of an intelligent app, on which text data of the received speech input is displayed.

According to an embodiment, on a screen 1020, the electronic device 101 may display a result corresponding to a received speech input on a display. For example, the electronic device 101 may receive, from the server 108, a result of processing an operation corresponding to a received user input or determine the operation processing result, and the electronic device 101 may display “the schedule of this week” on the display according to the received or determined operation processing result.

While the disclosure has been shown and described with reference to various embodiments thereof, it will be understood by those skilled in the art that various changes in form and details may be made therein without departing from the spirit and scope of the disclosure as defined by the appended claims and their equivalents.

1. An electronic device comprising:
a processor; and
a memory operatively connected to the processor,
wherein the memory stores instructions which, when executed, cause the processor to:
generate multiple sound sources for a designated text including at least one designated word, based on a personalized text-to-speech model constructed with a designated user voice, and
perform deep learning of a personalized automatic speech recognition model by using the multiple generated sound sources.

2. The electronic device of claim 1, wherein the instructions which, when executed, further cause the processor to:
perform filtering for the multiple generated sound sources; and
perform deep learning of the personalized automatic speech recognition model by using the filtered sound sources.

3. The electronic device of claim 2, wherein the instructions which, when executed, further cause the processor to perform the filtering through a sound quality test based on at least one sound quality test method including a perceptual evaluation of speech quality (PESQ) for the multiple generated sound sources.

4. The electronic device of claim 2, wherein the instructions which, when executed, further cause the processor to perform the filtering by performing automatic speech recognition for the multiple generated sound sources to convert the sound sources into text, and comparing the converted text with the designated text.

5. The electronic device of claim 2, wherein the instructions which, when executed, further cause the processor to:
perform pitch tracking for the multiple generated sound sources; and
perform filtering for the multiple generated sound sources based on a designated pitch range.

6. The electronic device of claim 2, wherein the instructions which, when executed, further cause the processor to:
determine a sound length for each of phonemes included in the multiple generated sound sources; and
perform filtering for the multiple generated sound sources based on a designated sound length range.

7. The electronic device of claim 1, wherein the instructions which, when executed, further cause the processor to generate the multiple sound sources by transforming at least one of a sound length and a sound pitch for each of phonemes of a phoneme sequence included in the text, based on the personalized text-to-speech model.

8. The electronic device of claim 7, wherein the instructions which, when executed, further cause the processor to:
switch the text into a phoneme sequence; and
extract information required for generation of the multiple sound sources based on the sequence and relationship of phonemes included in the phoneme sequence.

9. The electronic device of claim 8, wherein the instructions which, when executed, further cause the processor to:
allocate at least one prosody frame to each of phonemes included in the phoneme sequence;
determine a value of the prosody frame based on the extracted information; and
convert the determined value of the prosody frame into a spectrogram value so as to generate a sound source for each of the phonemes.

10. The electronic device of claim 9, wherein the instructions which, when executed, further cause the processor to:
receive clustered prosody information corresponding to the phoneme sequence; and
transform at least one of a sound length and a sound pitch of each of the phonemes based on the clustered prosody information.

11. A method by an electronic device, the method comprising:
generating multiple sound sources for a designated text including at least one designated word, based on a personalized text-to-speech model constructed with a designated user voice; and
performing deep learning of a personalized automatic speech recognition model by using the multiple generated sound sources.

12. The method of claim 11, further comprising performing filtering for the multiple generated sound sources,
wherein the deep learning performs deep learning of the personalized automatic speech recognition model by using the filtered sound sources.

13. The method of claim 12, wherein the filtering for the multiple generated sound sources comprises performing the filtering through a sound quality test based on at least one sound quality test method including a perceptual evaluation of speech quality (PESQ) for the multiple generated sound sources.

14. The method of claim 12, wherein the filtering for the multiple generated sound sources comprises performing the filtering by performing speech recognition of the multiple generated sound sources to convert the sound sources into text and comparing the converted text with the designated text.

15. The method of claim 12, wherein the filtering for the multiple generated sound sources comprises:
performing pitch tracking for the multiple generated sound sources; and
performing filtering for the multiple generated sound sources based on a designated pitch range.

16. The method of claim 12, wherein the filtering for the multiple generated sound sources comprises:
determining a sound length for each of phonemes included in the multiple generated sound sources; and
performing filtering for the multiple generated sound sources based on a designated sound length range.

17. The method of claim 11, wherein the generating of the multiple sound sources comprises generating the multiple sound sources by transforming at least one of a sound length and a sound pitch for each of phonemes of a phoneme sequence included in the text, based on the personalized text-to-speech model.

18. The method of claim 17, wherein the generating of the multiple sound sources comprises:
switching the text into a phoneme sequence; and
extracting information required for generation of the multiple sound sources based on the sequence and relationship of phonemes included in the phoneme sequence.

19. The method of claim 18, wherein the generating of the multiple sound sources comprises:
allocating at least one prosody frame to each of phonemes included in the phoneme sequence;
determining a value of the prosody frame based on the extracted information; and
converting the determined value of the prosody frame into a spectrogram value so as to generate a sound source for each of the phonemes.

20. The method of claim 19, wherein the generating of the multiple sound sources comprises:
receiving clustered prosody information corresponding to the phoneme sequence; and
transforming at least one of a sound length and a sound pitch of each of the phonemes based on the clustered prosody information.
